(19) United States
(12) Patent Application Publication
(10) Pub. No.: US 2007/0059330 A1
(43) Pub. Date: Mar. 15, 2007

(54) Insecticidal agent, method for the preparation thereof and a method for controlling insects

(76) Inventors: Samindra Nath Mukherjee, Maharashtra (IN); Pushpa Vijay Pawar, Maharashtra (IN); Praphulla Narahar Joshi, Maharashtra (IN); Mahesh Wamanrao Kasture, Maharashtra (IN); Rajiv Kumar, Maharashtra (IN)

Correspondence Address: SCHWEITZER CORNMAN GROSS & BONDELL LLP, 292 MADISON AVENUE - 19th FLOOR, NEW YORK, NY, 10017, US

(21) Appl. No.: 11/392,996

(22) Filed: Mar. 29, 2006

(30) Foreign Application Priority Data
Sep. 12, 2005 (IN) 3330/DEL/2005

(51) Int. Cl. A01N 59/00; A01N 59/16; A01N 25/00

(52) U.S. Cl. 424/405; 424/125; 424/617

(57) ABSTRACT

The present invention provides an insecticidal agent useful for the controlling the insect pests belonging to the order Lepidoptera viz. Helicoverpa armigera, Pectinophora gossypiella, Spodoptera litura, or Earias vitella or mixed populations thereof on different crops comprising inorganic molecular sieve dissolved in water and naturally occurring inert adhesive such as gum arabica or any other commercially available inert sticker. It also deals with an effective method for controlling the said insect pests using said insecticidal agent. Because of very high activity, low application rates of these compounds are employed for maintaining the control of the pest. These relatively low application rates, together with practically no mammalian toxicity possessed by the compounds of the present invention makes them more effective as well as eco-friendly.

### FIELD OF INVENTION

The present invention relates to an insecticidal agent useful for the controlling the insect pests belonging to the order Lepidoptera viz. Helicoverpa armigera, Pectinophora gossypiella, Spodoptera litura, or Earias vitella or mixed populations thereof.

More particularly, it relates to a method for the preparation of said agent.

Further, it also relates to an effective method for controlling the insect pests belonging to the order Lepidoptera viz. Helicoverpa armigera, Pectinophora gossypiella, Spodoptera litura, or Earias vitella or mixed populations thereof on different crops using an insecticidally effective amount of insecticidal agent.

### BACKGROUND AND PRIOR ART OF THE INVENTION

Cotton is the most widely used natural fiber in the manufacture of clothing it has been chosen as an example because of its high commercial value as well as because of the fact that this crop utilizes the maximum amount of conventional insecticides to take care if its pests. It is a soft, downy substance consisting of hairs or fibers attached to the seeds of plants belonging to the genus Gossypium of the Malvaceae family. As it is a plant it can be cultured in much larger quantity and at much less cost than producing animal fibers as in raising sheep for wool. The extensive use of cotton around the world as a textile fabric owes primarily to the fact that individual cotton fibers have a natural spiral twist, giving it a strength and reliance unmatched by other plant fibers. Cotton is used in making fabrics, thread, wadding, etc. About 20 million tones of cotton are produced each year in around 90 countries; China, USA, India, Pakistan, Uzbekistan and West Africa account for over 75% of global production. Cotton represents nearly half the fiber used to make clothes and other textiles worldwide, with much of the rest coming from synthetic products.

Cotton production is a challenging business. Not only does cotton require a warm climate with sufficient light and water supply, the cotton plant is also highly susceptible to pests and diseases. Such pests and diseases cause serious losses in crop yield if not treated appropriately. Bollworms, budworms, armyworms, aphids, whiteflies, stinkbugs and boll weevils are just a few of the many insects attacking the plant.

Insect pests are primarily responsible for the low yield of cotton. Cotton is inhabited by 162 insect species of which a dozen or so are economically important causing considerable yield reduction [Dhawan, A. K., Sidhu, A. S., Simwat, G. S., Indian J. Agric. Sci. 58 (1988) 290-292, Satpute, U. S., Sarnaik, D. N., Bhalerao, P. D., Indian J. Plant Prot. 16, (1988) 37-39]. For example, the seriousness of the pest problem can be judged from the fact that cotton alone receives 54% of the total insecticides used in plant protection in India alone. The cotton bollworm complex includes the old world bollworm, Helicoverpa armigera (Hubner); spotted bollworm, Earias vittella (Fabricius); spiny bollworm, E. insulana (Boisduval) and pink bollworm, Pectinophora gossypiella (Saunders). Among the bollworms, H. armigera is the most important and difficult to control and crop losses in India alone due to this pest are estimated to be US $350 million annually. The indiscriminate use of insecticides at all stages of the cotton crop has resulted in resurgence of pests especially of H. armigera. This pest has developed resistance to many groups of insecticides, particularly the synthetic pyrethroids [Armes, N. J., Jadhav, D. R., De Souza, K. R., 1996. Bulletin of Entomological Research 86 (1996) 499-514]. Also the adverse effect of insecticides on the natural enemy complex on cotton has compounded the bollworm management problem.

Insecticides have been available for more than a century and are being applied to vegetables, fruits and crops to reduce damage by insects. Especially in cotton, farmers need to spend a significant part of their production costs to protect their fields from insects. Some 20% of insecticides used to protect plants in agriculture are applied to cotton. Most of the insecticides are used as sprays on top of plants throughout the growing season. In addition, insecticides can also be coated onto seeds so that the germinating seeds and young plants are protected against certain insects. In the last decades there have been major innovations in insect control. Insecticides with a broad spectrum of activity are being replaced by insecticides that are highly specific for the targeted pest insect and are, therefore, very efficient to use and also friendly for the environment. Although, organic chemical based pesticides in general are helpful in pest control, they also pose sever risk to humans. Further, despite this massive use of certain organic chemical based pesticides, yields are declining in many parts of the world Cotton growers give up vast acreage of cotton when pesticides became too expensive and not effective enough due to the insect's ability to develop resistance toward the insecticides in due course. With chemical dependence, shrinking yields, and decreasing income from crops, the agricultural picture is too often a grim one.

The cotton crop is a major consumer of pesticides with generally around 10% of the end-user market value. Until recently, the organophosphate group, one of the most hazardous to worker's health, took a major part of the insecticide market, but there has been a shift to pyrethroid in recent years. The most important insecticides were deltamethrin, lambda-cyhalothrin, monocrotophos, alpha-cypermethrin, chlorpyriphos-ethyl, esfenvalerate, methamidophos and dimethoate. Other insectides such as azinphos-methyl, diazinon, dimethoate, malathion, parathion, phospamidon, quinalphos, bifenthrin, beta-cyfluthrin, esfenvalerate, tralomethrin, aldicarb, carbaryl, carbofuran, fenobucarb, methomyl and thiodicarb contribute to rest of the share. From these active insecticides particularly organophosphates, create problems in connection with the undue hazard to beneficial insects, health damage due to high toxicity, damage to the environment and rendering farm field barren with prolonged usage.

The search for compounds which have a combination of excellent insecticidal activity towards target insects and low toxicity towards non-target species is a continuing one because of factors such as the desire for compounds exhibiting greater activity, better selectivity, low undesirable environmental impact, lack of phytotoxicity to the locus of application, lower production and market cost and higher effectiveness against insects resistant to many known insecticides. For example, Helicoverpa armigera is known to develop resistance towards the use of commercial insecticides like cypermethrin, fevalerate, quinalphos and endosulfan in due course of prolonged usage. The resistance towards the insecticidal activity, mainly due to neuro-toxic properties of the insecticides developed by the insects towards the insecticides is mainly due to the reason that they develop detoxification mechanism towards such insecticides. Due to the above mentioned drawbacks of insecticides based on organic chemicals certain naturally occurring inorganic compounds have been tried and used as insecticide. For example, silica, and diatomaceous earth are used against a wide variety of stored-grain insect pests like the red flour beetle, Tribolium castaneum; confused flour beetle, Tribolium confusum; the bruchids, Callosobruchus chinensis, Callosobrtchus maculatus; and the rice weevil, Sitophilus oryzae in protecting the harvested grains during storage. Certain inorganic substances may cause the injury to the insect on physical contact when sorptive property of such inorganic substances could damage the protective lipid layer that covers the cuticle of the insect and insect may lose body moisture through the damaged spots on their cuticle and die after a certain time due to desiccation or dehydration. While there are some reports of the use of inorganic compounds as insecticides for grain storage, there are no reports on their use in crop protection. This could be due to the reason that while it is rather very easy and effective to apply the non-volatile inorganic compounds in a confined area of grain storage, such application are difficult for crops in the field due to large and open area. The wind and rain may further restrict the applicability and use of non-sticky inorganic substrates in crop protection. Considering above mentioned drawbacks and limitations of both organic and the conventionally used inorganic compounds as insecticides in crop protection, it was thought worthwhile to systematically study the application of non-hazardous inorganic molecular sieves which contain well defined characteristics like unique structure and physicochemical properties in crop protection. Further, in addition to the sorptive ability, some inorganic molecular sieves can also have abrasive properties. When eaten, such inorganic molecular sieves may act on the digestive tract or may cause suffocation of the insects. These two effects may work in combination. These inorganic molecular sieves can be well dispersed in water and are chemically inert to the environment.

A “molecular sieve” is a material with selective adsorption properties capable of separating components of a mixture on the basis of a difference in molecular size and shape. Molecular sieves include clays, porous glasses, microporous charcoals, active carbons, zeolites and related materials etc. Zeolites are three-dimensional, microporous, crystalline solids with well-defined structures that contain aluminum, silicon, and oxygen in their regular framework; cations and water are located in the pores. The silicon and aluminum atoms are tetrahedrally coordinated with each other through shared oxygen atoms. A representative empirical formula of a zeolite is M_{2/n}O.Al₂O₃.xSiO₂.yH₂O where M represents the exchangeable cation of valence n. M is generally a Group I or II ion, although other metal, non-metal and organic cations may also balance the negative charge created by the presence of Al in the structure. There are numerous naturally occurring and synthetic zeolites, each with a unique structure. The pore sizes of commercially available zeolites range from approximately 3 Å to approximately 8 Å. Some of the commercial materials are: A, beta, mordenite, Y, ZSM-5.

There are a number of different ways that zeolites can be modified. Such modifications in a zeolite are accompanied by an alteration of stability, adsorption behaviour and selectivity, catalytic activity and other properties. The extra-framework cations can be exchanged by other desired metal/non-metal or organic cations. The framework of the zeolite can be modified by synthesizing zeolites with metal cations other than aluminum and silicon in the framework. The framework composition of the zeolites can be modified by dealumination to decrease the alumina content and increase the hydrophobic nature of the zeolite. The combination of many properties that make zeolites unique among inorganic oxides are: the microporous character of the uniform pore dimensions, the ion exchange properties, the ability to develop internal acidity, the high thermal stability, the high internal surface area.

Zeolites contribute to a cleaner, safer environment in a great number of ways. In fact nearly every application of zeolites has been driven by environmental concerns, contributing in reducing toxic waste and energy consumption. Extensive studies have been done on representative zeolite A due to its use in consumer products. These studies have demonstrated that zeolite A is essentially non-toxic via oral, dermal, ocular routes of exposure and safe for the environment [Frederick A. Mumpton, Proc. Natl. Acad. Sci. USA 96 (1999) 3463-3470].

It is, therefore, an object of the present invention to provide an effective method for controlling the Helicoverpa armigera, and other insect pests belonging to the Order: Lepidoptera viz. Pectinophora gossypiella, Spodoptera litura, Earias vitella on different crops using an insecticidally effective amount of certain inorganic molecular sieves that have high activity against such pests. Through a systematic study using H. armigera as the representative example, because of its tolerance to most of the currently used conventional pesticides, we have found out that inorganic molecular sieves exhibit very high insecticidal activity against the target pest. However, the other insect pests as mentioned earlier other than H. armigera have also been studied. Thus it should not be construed that the insecticidal activity of the compounds mentioned in Table 1 are effective against H. armigera only. Because of the high activity, and consequently low application amounts of these compounds together with practically no mammalian toxicity possessed by the compounds of the present invention, there is no adverse impact on the environment with no or considerably reduced risk to the applicator along with lower cost of application.

### OBJECT OF THE INVENTION

The main object of the present invention is to provide an insectcidal agent useful for the controlling the insect pests belonging to the order Lepidoptera viz. Helicoverpa armigera, Pectinophora gossypiella, Spodoptera litura, or Earias vitella or mixed populations thereof on different crops.

Another object of the present invention is to provide a method for the preparation of insecticidal agent.

Further, another object of the present invention is to provide an effective method for controlling the insect pests belonging to the order Lepidoptera viz. Helicoverpa armigera, Pectinophora gossypiella, Spodoptera litura, or Earias vitella or mixed populations thereof on different crops. Yet another object of the present invention is to provide an effective method for controlling the insect pests using said insecticidal agent.

### SUMMARY OF INVENTION

The present invention deals with an insecticidal agent useful for the controlling the insect pests belonging to the order Lepidoptera viz. Helicoverpa armigera, Pectinophora gossypiella, Spodoptera litura, or Earias vitella or mixed populations thereof on different crops, wherein the said agent comprising inorganic molecular sieve dissolved in water and naturally occurring inert adhesive such as gum arabica or any other commercially available inert sticker wherein the ratio of the individual component is in the range of 5:1 to 1:4. It also relates to a method for the preparation of insecticidal agent. Further, the present invention also provides an effective method for controlling the said insect pests using said insecticidal agent.

### DETAILED DESCRIPTION OF THE INVENTION

Present invention relates to an effective method for controlling the Helicoverpa armigera, Pectinophora gossypiella, Spodoptera litura, Earias vitella on different crops using an insecticidally effective amount of insecticidal agent that have significantly high activity against such pests. Because of very high activity, low application rates of these compounds are employed for maintaining the control of the pest. These relatively low application rates, together with practically no mammalian toxicity possessed by the compounds of the present invention makes them more effective as well as eco-friendly.

Further, the invention relates to an effort in further improvements in insecticides in order to maximize the control of pest insects in environmentally friendly and sustainable way. It is a feature of the invention to use well-defined inorganic molecular sieves for averting the insect-induced damages to various crops.

Accordingly, the present invention provides an insectcidal agent useful for the controlling the insect pests belonging to the order Lepidoptera viz. Helicoverpa armigera, Pectinophora gossypiella, Spodoptera litura, or Earias vitella or mixed populations thereof on different crops, wherein the said agent comprising inorganic molecular sieve dissolved in water and inert adhesive/sticker, wherein the ratio of the individual component used is in the range of 5:1 to 1:4. In an embodiment of the present invention, the inorganic molecular sieves are selected from clays, porous glasses, microporous charcoals, active carbons, zeolites such as A, X, Y, ZSM-5, ZSM-12, Beta, K-L, mordenite, kaolin, montmorrilonite, chabazite, nitrolite or mixtures thereof. In another embodiment of the present invention, the zeolite used as inorganic molecular sieve contains trivalent cations such as Al, Fe, B, Ga or Ce or mixtures thereof and/or tetravalent cations such as Si, Ti, Zr or mixtures thereof in the framework position and H⁺, Na⁺, K⁺, NH₄⁺, Cu⁺, Cu²⁺, La³⁺, organic cations such as tetrapropylammonium (TPA⁺), tetraethylammonium (TEA⁺) or mixture thereof as the charge compensating or nonframework cations.

Further in another embodiment of the present invention, the zeolite used as inorganic molecular has a general formula M_{2/n}O.A₂O₃.xB₂O.yH₂O where M=the exchangeable cation of valancen, A=trivalent cations and B=tetravalent cations and their molar B₂O/A₂O₃ ratio in the range of 2 to infinity. The particle size of these molecular sieves is in the range of 30 nm to 10 μm.

Further in another embodiment of the present invention, the pore size of said inorganic molecular sieves is ≧2.5 Å.

Yet in another embodiment of the present invention, the inert adhesive/stickers used is selected from the group consisting of gum arabica, latex (rubber), polyethylene (plastic), resins (rosin), polymenthenes (rosin-like) or mixture thereof.

Still in another embodiment of the present invention, the concentration of inorganic molecular sieve used in the slurry is in the range of 0.1 to 5 wt %.

Still in another embodiment of the present invention, the concentration of inorganic molecular sieve used in the slurry preferably is in the range of 1-2 wt %.

Still in another embodiment of the present invention, the concentration of inert adhesive/sticker used in the slurry is in the range of 0.02 to 2.0-wt %.

Still in another embodiment of the present invention, the concentration of inert adhesive/sticker used in the slurry preferably is in the range of 0.1-0.5 wt %.

Further, the present invention provides a method for the preparation of said insecticidal agent, wherein the said method comprising the steps of:
a) providing fine inorganic molecular sieve or optionally grinding of inorganic molecular sieve followed by sieving to obtain fine inorganic molecular sieve;
b) dispersing the fine inorganic molecular sieve obtained from step (a) in water in such a way that aqueous slurry contain 0.1-5% wt inorganic molecular sieve and 0.02-2.0 wt % of naturally occurring inert adhesive/sticker to allow the slurry to stick to plant surface for desired effect.

In an embodiment of the present invention, the inorganic molecular sieves are selected from clays, porous glasses, microporous charcoals, active carbons, zeolites such as A, X, Y, ZSM-5, ZSM-12, Beta, K-L, mordenite, kaolin, montmorrilonite, chabazite, nitrolite or mixtures thereof. In another embodiment of the present invention, the zeolite used as inorganic molecular sieve contains trivalent cations such as Al, Fe, B, Ga or Ce or mixtures thereof and/or tetravalent cations such as Si, Ti, Zr or mixtures thereof in the framework position and H⁺, Na⁺, K⁺, NH₄⁺, Cu⁺, Cu²⁺, La³⁺, organic cations such as tetrapropylammonium (TPA⁺), tetraethylammonium (TEA⁺) or mixture thereof as the charge compensating or nonframework cations.

Further in another embodiment of the present invention, the pore size of said inorganic molecular sieves is ≧2.5 Å.

Yet in another embodiment of the present invention, the inert adhesive/sticker is selected from the group consisting of that contain latex (rubber), polyethylene (plastic), resins (rosin), polymenthenes (rosin-like) or mixture thereof for the purpose of allowing the slurry to stick to plant surface for desired effect.

The present invention also provides an effective method for controlling the insect pests belonging to the order Lepidoptera viz. Helicoverpa armigera, Pectinophora gossypiella, Spodoptera litura, or Earias vitella or mixed populations thereof on different crops using an insecticidally effective amount of said insecticidal agent, wherein the said method comprising the steps of:
a) providing insecticidal agent;
b) treating the crop plant with insecticidal agent obtained from step (a) by conventional method selected from the group of painting, dipping or spraying;
c) feeding of late first instar larvae, late second instar larvae and late third instar larvae of the individual cotton insect pest belonging to the order Lepidoptera viz. Helicoverpa armigera, Pectinophora gossypiella, Spodoptera litura, or Earias vitella or mixed populations thereof on treated crop plant obtained from step (b);
d) observing the mortality of late first instar larvae, late second instar larvae and late third instar larvae of the individual cotton insect pest belonging to the order Lepidoptera viz. Helicoverpa armigera, Pectinophora gossypiella, Spodoptera litura, or Earias vitella or mixed populations thereof after every 24 h until 100% mortality occurred.

In an embodiment of the present invention, the crop plant is selected from the group of cotton, sorghum, safflower, pigeon pea, tobacco, lady's finger, tomato, maize, castor, groundnut, cabbage, soyabean or sweet potato.

The following examples are given by way of illustration of the present invention and should not be construed to limit the scope of present invention.

### EXAMPLE 1

Insecticidal Activity of Various Inorganic Molecular Sieves Against Helicoverpa armigera:

First, second and third instar larvae of the cotton bollworm Helicoverpa armigera, were fed on cotton leaf discs treated with dispersion of fine inorganic molecular sieve in water in such a way that aqueous slurry should contain 1% wt solid samples and a 0.2 wt % gum arabica separately (Table 1). Observation on mortality was taken every 24 h until 100% mortality occurred. Simultaneous controls were maintained along side. The experiment was replicated three times with thirty larvae each time. The results are given in Table 1.

TABLE 1
Effect of inorganic molecular sieves on larval instars of H. armigera

| | | Time taken for | | |
|---|---|---|---|---|
| Entry | | 100% mortality (hours) | | |
| No. | Insecticide | Instar 1 | Instar 2 | Instar 3 |
| 1 | H/Beta | 48 | 72 | 120 |
| 2 | NaA | 48 | 120 | 192 |
| 3 | Mordenite | 96 | 144 | 168 |
| 4 | Kaolin | 48 | 120 | 144 |
| 5 | Na/ZSM-5 | 48 | 96 | 216 |
| 6 | H/ZSM-5 | 48 | 144 | 216 |
| 7 | Cu-A | 48 | 96 | 192 |
| 8 | Nitrolite | 96 | 192 | 240 |
| 9 | Montmorilonite | 96 | 192 | 240 |

| | | |
|---|---|---|
| 10 | Control | Continued to grow on food |

### EXAMPLE 2

Insecticidal Activity of Various Inorganic Molecular Sieves Against Pectinophora gossypiella:

Larvae of Pectinophora gossypiella were fed on host plant treated with dispersion of fine inorganic molecular sieve in water in such a way that aqueous slurry should contain 0.5% wt solid and a 0.1 wt % of gum arabica. Treated as well as untreated host plants were replenished every alternate day. Observation on mortality was taken every 24 h until 100% mortality occurred. Simultaneous controls were maintained along side. The experiment was replicated three times with thirty larvae each time. The results are given in Table 2.

TABLE 2
Effect of different inorganic molecular sieves on different larval instars of
Pectinophora gossypiella.

| | | Time taken for | | |
|---|---|---|---|---|
| Entry | | 100% mortality (hours) | | |
| No. | Insecticide | Instar 1 | Instar 2 | Instar 3 |
| 1 | H/Beta | 65 | 80 | 100 |
| 2 | NaA | 65 | 105 | 170 |
| 3 | Mordenite | 80 | 125 | 150 |
| 4 | Kaolin | 70.0 | 105.0 | 130.0 |
| 5 | Na/ZSM-5 | 60.0 | 100.0 | 200.0 |
| 6 | H/ZSM-5 | 65.5 | 132.0 | 200.0 |
| 7 | CuA | 65.5 | 105.5 | 170.0 |

| | | |
|---|---|---|
| 8 | Control | Continued to grow on food |

### EXAMPLE 3

Insecticidal Activity of Various Inorganic Molecular Sieves Against Earias vitella:

Larvae of Earias vitella were fed on host plant treated with dispersion of fine inorganic molecular sieve in water in such a way that aqueous slurry should contain 2% wt solid and a 0.4 wt % of gum arabica. Treated as well as untreated host plants were replenished every alternate day. Observation on mortality was taken every 24 h until 100% mortality occurred. Simultaneous controls were maintained along side. The experiment was replicated three times with thirty larvae each time. The results are given in Table 3.

TABLE 3
Effect of inorganic molecular sieves on larval instars of Earias vitella

| | | Time taken for 100% | | |
|---|---|---|---|---|
| Entry | | mortality (hours) | | |
| No. | Insecticide | Instar 1 | Instar 2 | Instar 3 |
| 1 | H/Beta | 66 | 82.0 | 101.2 |
| 2 | Na/A | 68 | 108.5 | 172.0 |
| 3 | Mordenite | 82 | 128.5 | 152.0 |
| 4 | Kaolin | 75.0 | 125.0 | 135.0 |
| 5 | Na/ZSM-5 | 62.0 | 105.0 | 205.0 |
| 6 | H/ZSM-5 | 65 | 110.0 | 205.0 |
| 7 | CU/A | 65 | 105.5 | 165.0 |

| | | |
|---|---|---|
| 8 | Control | Continued to grow on food |

### EXAMPLE 4

Insecticidal Activity of Various Inorganic Molecular Sieves Against Spodoptera litura:

Larvae of Spodoptera litura were fed on host plant treated with dispersion of fine inorganic molecular sieve in water in such a way that aqueous slurry should contain 5% wt solid and a 0.5 wt % of gum arabica. Treated as well as untreated host plants were replenished every alternate day. Observation on mortality was taken every 24 h until 100% mortality occurred. Simultaneous controls were maintained along side. The experiment was replicated three times with thirty larvae each time. The results are given in Table 4.

TABLE 4
Effect of inorganic molecular sieves on larval instars of Spodoptera litura

| | | Time taken for 100% | | |
|---|---|---|---|---|
| Entry | | mortality (hours) | | |
| No. | Insecticide | Instar 1 | Instar 2 | Instar 3 |
| 1 | H/Beta | 62 | 78 | 105 |
| 2 | NaA | 64 | 102 | 165 |
| 3 | Mordenite | 88.5 | 130.5 | 155 |
| 4 | Kaolin | 80.0 | 100.0 | 140 |
| 5 | Na/ZSM-5 | 61.0 | 110.0 | 196 |
| 6 | H/ZSM-5 | 64.5 | 135.0 | 202 |
| 7 | CuA | 65.5 | 108.5 | 160.0 |

| | | |
|---|---|---|
| 8 | Control | Continued to grow on food |

### EXAMPLE 5

Insecticidal Activity of Various Inorganic Molecular Sieves Against Helicoverpa armigera:

The third instar larvae weighing 120-130 mg of the cotton bollworm, Helicoverpa armigera were fed on cotton leaf discs treated with dispersion of fine inorganic molecular sieve in water in such a way that aqueous slurry should contain 1% wt solid and a 0.2 wt % of gum arabica separately. Treated as well as untreated leaves were replenished every alternate day Larval weights were taken at 0 hr, and then every 24 hrs till larval death. Simultaneous controls were maintained. The experiment was replicated three times with thirty larvae each time. The results are given in Table 5.

TABLE 5
Effect on larval weight of the third instar larvae of H. armigera

| | Mean larval weight (mg) on days after | | | | | | | |
|---|---|---|---|---|---|---|---|---|
| | treatment against 3rd instar larvae | | | | | | | |
| Insecticide | 0 | 1 | 2 | 3 | 4 | 5 | 6 | 7 |
| Control | 125.2 ± 0.5 | 147.2 ± 0.6 | 169.6 ± 1.0 | 186.4 ± 0.5 | 231.0 ± 1.7 | 276.0 ± 1.2 | 322.3 ± 1.1 | |
| H/ZSM-5 | 126.2 ± 0.5 | 145.3 ± 1.0 | 156.5 ± 1.5 | 137.7 ± 1.2 | 130.1 ± 0.9 | 120.0 ± 0.9 | 108.35 ± 2.2 | M* |
| H/Beta | 126.1 ± 0.5 | 132.0 ± 0.6 | 109.8 ± 1.2 | 94.0 ± 1.9 | M* | | | |
| Na/ZSM-5 | 125.5 ± 0.5 | 134.8 ± 3.4 | 148.3 ± 0.9 | 129.9 ± 0.9 | 117.1 ± 1.5 | 96.1 ± 1.9 | 88.8 ± 1.8 | M* |
| NaA | 125.8 ± 0.5 | 131.4 ± 0.9 | 145.8 ± 1.2 | 122.9 ± 2.1 | 103.6 ± 2.6 | 89.8 ± 1.6 | 86.3 ± 1.5 | M* |

M* = 100% mortality

### EXAMPLE 6

Effect of the Various Inorganic Molecular Sieves:

Glass petri dish with a total surface area of ca 177.2 cm² (including the upper and lower dish) were treated with 0.67 ml (upper dish) and 1.67 ml (lower dish) of dispersion of fine inorganic molecular sieve in water in such a way that aqueous slurry should contain 1% wt solid and a 0.2 wt % of gum arabica. H. armigera larvae were subjected to treatment without food for the first 48 h surviving larvae were then provided with food and subsequently mortality was observed every 24 h. One larva was released per petri dish per sample and this was replicated 10 times for each sample. Simultaneous controls were maintained. The results are given in Table 6.

TABLE 6
Effect of residual film treatment on third instar larvae of H. armigera

| | | | Time taken for | |
|---|---|---|---|---|
| | | | mortality | Time taken for |
| Sample | Concentration | Mortality | (without food) | mortality (with |
| Code | (%) | (%) | (days) | food) (days) |
| Control | NIL | 10 | 3 | — |
| NaA | 1% | 50 | 2 | 5 |
| | 1% | 50 | 4 | 10 |
| H/Beta | 1% | 50 | 1 | — |
| | 1% | 50 | 2 | — |
| H/ZSM-5 | 1% | 50 | 1 | — |
| | 1% | 50 | 5 | 10 |

Advantage:
1. Because of the high activity, and consequently low application amounts of the compounds used in present invention together with practically no mammalian toxicity possessed which makes it more effective as well as eco friendly.
2. There is no adverse impact on the environment with no or considerably reduced risk to the applicator along with the lower cost of the invention;

We claim:

1. An insectcidal agent useful for the controlling the insect pests belonging to the order Lepidoptera viz. Helicoverpa armigera, Pectinophora gossypiella, Spodoptera litura, or Earias vitella or mixed populations thereof on different crops, wherein the said agent comprising inorganic molecular sieve dissolved in water and inert adhesive/sticker, wherein the ratio of the individual component used is in the range of 5:1 to 1:4.

2. An insectcidal agent according to claim 1, wherein the inorganic molecular sieves are selected from clays, porous glasses, microporous charcoals, active carbons, zeolites such as A, X, Y, ZSM-5, ZSM-12, Beta, K-L, mordenite, kaolin, montmorrilonite, chabazite, nitrolite or mixtures thereof.

3. An insceticidal agent according to claim 2, wherein the zeolite used as inorganic molecular sieve contains trivalent cations such as Al, Fe, B, Ga or Ce or mixtures thereof and/or tetravalent cations such as Si, Ti, Zr or mixtures thereof in the framework position and H⁺, Na⁺, K⁺, NH₄⁺, Cu⁺, Cu²⁺, La³⁺, organic cations such as tetrapropylammonium (TPA⁺), tetraethylammonium (TEA⁺) or mixture thereof as the charge compensating or nonframework cations.

4. An insecticidal agent according to claim 2, wherein the pore size of said inorganic molecular sieves is ≧2.5 Å.

5. An insecticidal agent according to claim 1, wherein the inert adhesive/stickers used is selected from the group consisting of gum arabica, latex (rubber), polyethylene (plastic), resins (rosin), polymenthenes (rosin-like) or mixture thereof.

6. An insecticidal agent according to claim 1, wherein the concentration of inorganic molecular sieve used is in the range of 0.1 to 5 wt %.

7. An insecticidal agent according to claim 1, wherein the concentration of inorganic molecular sieve used in the slurry preferably is in the range of 1-2 wt %.

8. An insecticidal agent according to claim 1, wherein the concentration of inert adhesive/sticker used is in the range of 0.02 to 2.0-wt %.

9. An insectcidal agent according to claim 1, wherein the concentration of inert adhesive/sticker used in the slurry preferably is in the range of 0.1-0.5 wt %.

10. A method for the preparation of insecticidal agent according to claim 1, wherein the said method comprising the steps of:
a) providing fine inorganic molecular sieve or optionally grinding of inorganic molecular sieve followed by sieving to obtain fine inorganic molecular sieve;
b) dispersing the fine inorganic molecular sieve obtained from step (a) in water in such a way that aqueous slurry contain 0.1-5% wt inorganic molecular sieve and 0.02-2.0 wt % of naturally occurring inert adhesive/sticker to allow the slurry to stick to plant surface for desired effect.

11. A method according to claim 10, wherein the inorganic molecular sieves are selected from clays, porous glasses, microporous charcoals, active carbons, zeolites such as A, X, Y, ZSM-5, ZSM-12, Beta, K-L, mordenite, kaolin, montmorrilonite, chabazite, nitrolite or mixtures thereof.

12. A method according to claim 11, wherein the zeolite used as inorganic molecular sieve contains trivalent cations such as Al, Fe, B, Ga or Ce or mixtures thereof and/or tetravalent cations such as Si, Ti, Zr or mixtures thereof in the framework position and H⁺, Na⁺, K⁺, NH₄⁺, Cu⁺, Cu²⁺, La³⁺, organic cations such as tetrapropylammonium (TPA⁺), tetraethylammonium (TEA⁺) or mixture thereof as the charge compensating or nonframework cations.

13. A method according to claim 10, wherein the pore size of said inorganic molecular sieves is ≧2.5 Å.

14. A method according to claim 10, wherein the inert adhesive/sticker is selected from the group consisting of that contain latex (rubber), polyethylene (plastic), resins (rosin), polymenthenes (rosin-like) or mixture thereof.

15. An effective method for controlling insect pests belonging to the order Lepidoptera viz. Helicoverpa armigera, Pectinophora gossypiella, Spodoptera litura, or Earias vitella or mixed populations thereof on different crops using an insecticidally effective amount of insecticidal agent according to claim 1, wherein the said method comprising the steps of:
a) providing insecticidal agent according to claim 1;
b) treating the crop plant with insecticidal agent obtained from step (a) by conventional method selected from the group of painting, dipping or spraying;
c) feeding of late first instar larvae, late second instar larvae and late third instar larvae of the individual cotton insect pest belonging to the order Lepidoptera viz. Helicoverpa armigera, Pectinophora gossypiella, Spodoptera litura, or Earias vitella or mixed populations thereof on treated crop plant obtained from step (b);
d) observing the mortality of late first instar larvae, late second instar larvae and late third instar larvae of the individual cotton insect pest belonging to the order Lepidoptera viz. Helicoverpa armigera, Pectinophora gossypiella, Spodoptera litura, or Earias vitella or mixed populations thereof after every 24 h until 100% mortality occurred.

16. An effective method according to claim 15, wherein the crop plant is selected from the group of cotton, sorghum, safflower, pigeon pea, tobacco, lady's finger, tomato, maize, castor, groundnut, cabbage, soyabean or sweet potato.
